(19) United States
(12) Patent Application Publication
(10) Pub. No.: US 2024/0045499 A1
(43) Pub. Date: Feb. 8, 2024

(54) INFORMATION PROCESSING APPARATUS, VEHICLE, AND NON-TRANSITORY STORAGE MEDIUM

(71) Applicant: TOYOTA JIDOSHA KABUSHIKI KAISHA, Aichi-ken (JP)

(72) Inventors: Kazunori WATANABE, Okazaki-shi (JP); Daisuke TANIZAKI, Kariya-shi (JP)

(21) Appl. No.: 18/362,972

(22) Filed: Aug. 1, 2023

(30) Foreign Application Priority Data
Aug. 3, 2022 (JP) 2022-123905

(51) Int. Cl. G06F 3/01

(52) U.S. Cl. CPC G06F 3/013; G06V 20/593

(57) ABSTRACT

An information processing apparatus, during the operation of a vehicle, when there is a fellow passenger in the vehicle and a predetermined condition determined according to the load of the driving operation of a driver of the vehicle is not met, displays POI (Point of Interest) information on an in-vehicle display of the vehicle.

### CROSS REFERENCE TO THE RELATED APPLICATION

This application claims the benefit of Japanese Patent Application No. 2022-123905, filed on Aug. 3, 2022 which is hereby incorporated by reference herein in its entirety.

### BACKGROUND

### Technical Field

The present disclosure relates to a technology for controlling the display of an in-vehicle display.

### Description of the Related Art

Patent Literature 1 discloses a technique related to displaying advertisement information in a display device of a moving body terminal. In the display device disclosed in Patent Literature 1, a route to the destination and image information existing on the route are displayed on a map. Furthermore, in the display device, advertisement information that is effective when the moving body terminal reaches the shooting coordinates of the image information is displayed.

### CITATION LIST

### Patent Literature

Patent Literature 1: Japanese Patent Application Laid-Open Publication No. 2010-102685

### SUMMARY

The purpose of the present disclosure is to display POI (Point of Interest) information at a more favorable timing in an in-vehicle display.

An information processing apparatus according to the first aspect of the present disclosure may comprise a controller, wherein
during the operation of a vehicle, when there is a fellow passenger in the vehicle and a predetermined condition determined according to the load of the driving operation of a driver of the vehicle is not met, the controller displays POI (Point of Interest) information on an in-vehicle display of the vehicle.

A vehicle according to the second aspect of the present disclosure may be equipped with
the information processing apparatus according to the first aspect; and
an in-vehicle display.

The non-transitory storage medium according to the third aspect of the present disclosure may be a non-transitory storage medium that stores a program that controls a computer mounted on a vehicle, wherein
during the operation of a vehicle, when there is a fellow passenger in the vehicle and a predetermined condition determined according to the load of the driving operation of a driver of the vehicle is not met, the program causes the computer to display POI (Point of Interest) information on an in-vehicle display of the vehicle.

According to the present disclosure, POI (Point of Interest) information can be displayed at a more suitable timing in the in-vehicle display.

### BRIEF DESCRIPTION OF THE DRAWINGS

FIG. 1 is a diagram indicating a schematic configuration of an information provision system according to a first embodiment.

FIG. 2 is a diagram indicating an example of POI information displayed on an in-vehicle display.

FIG. 3 is a block diagram for explaining the hardware configuration of an in-vehicle device and various devices mounted on a vehicle.

FIG. 4 is a block diagram schematically indicating an example of a functional configuration of an in-vehicle device.

FIG. 5 is a flowchart indicating a flow of process of displaying according to a first embodiment.

FIG. 6 is a flowchart indicating a flow of process of displaying according to a second embodiment.

### DESCRIPTION OF THE EMBODIMENTS

The information processing apparatus according to the first aspect of the present disclosure controls the display of the in-vehicle display. A vehicle equipped with an in-vehicle display is a vehicle driven by a driver. The in-vehicle display may be installed near the driver's seat in the vehicle interior.

In the information processing apparatus according to the present disclosure, the controller controls the display of POI (Point of Interest) information on the in-vehicle display. Here, the POI information is information about a specific facility or place on a map such as a store, a landmark, and a tourist spot. The POI information may include, for example, advertising advertisement information about a specific facility or place. The controller displays POI information related to the current position of the vehicle or the scheduled travel route (including the destination of the vehicle) on the in-vehicle display. Thereby, information that may be useful to a passenger in the vehicle can be provided to the passenger.

However, while the vehicle is in operation, it is preferable that the display of POI information on the in-vehicle display be restrained from affecting the driver's driving operation. Further, depending on the driving status of the vehicle, even if POI information is displayed on the in-vehicle display, it may be difficult for the driver to grasp the POI information. Therefore, it is conceivable to control the display of the in-vehicle display so that the POI information is displayed on the in-vehicle display only when the vehicle operation is stopped, that is, when the vehicle is parked. However, if such controls are implemented, the opportunity to provide potentially useful information to a passenger on board the vehicle will be greatly limited.

On the other hand, if there is a fellow passenger other than the driver in the vehicle, the fellow passenger can grasp the POI information even if it is difficult for the driver to grasp the POI information displayed on the in-vehicle display. Further, the load of the driving operation of the driver of the vehicle is not always constant, and changes depending on the driving situation or the surrounding situation of the vehicle. That is, in a situation where the driver needs to increase the degree of concentration on driving, the load of the driver's driving operation increases as compared to the case where the vehicle is not in such a situation. Then, in a situation where the load of the driving operation of the driver is high, it is desirable that the display of POI information on the in-vehicle display have less influence on the driver's driving operation than when the driver's driving operation load is low.

Therefore, in the information processing apparatus according to the present disclosure, during the operation of a vehicle, when there is a fellow passenger in the vehicle and a predetermined condition determined according to the load of the driving operation of a driver of the vehicle is not met, the controller may display POI information on an in-vehicle display of the vehicle. Here, the predetermined condition may be a condition in which the load on the driver's driving operation is higher than when the predetermined condition is not met when the predetermined condition is met. According to the above control, POI information can be provided to the fellow passenger even during vehicle operation, in a situation where the predetermined conditions are not met. That is, according to the present disclosure, POI information can be displayed at a more suitable timing in the in-vehicle display.

Specific embodiments of the present disclosure will be described below on the basis of the drawings. The technical scope of the present disclosure is not limited to sizes, materials, shapes, relative arrangement, and the like of constituent components described in the present embodiments unless otherwise described.

### FIRST EMBODIMENT

### System Overview

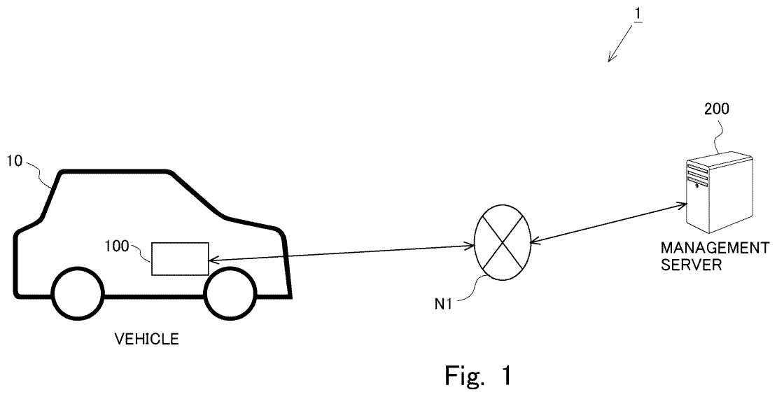

FIG. 1 is a diagram indicating a schematic configuration of the information provision system according to the first embodiment. The information providing system according to the present embodiment is a system for providing POI information to the passengers of a vehicle 10. Here, the vehicle 10 is a vehicle driven by a driver.

The information providing system 1 includes an in-vehicle device 100 and a management server 200. The in-vehicle device 100 is a device mounted on the vehicle 10. The in-vehicle device 100 includes a computer. The in-vehicle device 100 controls the display of an in-vehicle display of the vehicle 10. The management server 200 is a server that manages POI information. The management server 200 receives information transmitted from servers associated with various facilities or places that provide POI information. Then, the management server 200 manages the POI information received from each server.

In the information providing system 1, the in-vehicle device 100 and the management server 200 are connected to each other via the network N1. The network N1 may be, for example, a WAN (Wide Area Network), which may be a global public communication network such as the Internet, or a telephone communication network, such as cellular phone communication network.

The in-vehicle device 100 transmits route information including the current position of the vehicle 10 and the scheduled travel route of the vehicle 10 to the management server 200 via the network N1. When the management server 200 receives route information from the in-vehicle device 100, the management server 200 extracts POI information related to the current position of the vehicle 10 or the scheduled travel route of the vehicle 10. Then, the management server 200 transmits the extracted POI information to the in-vehicle device 100 via the network N1.

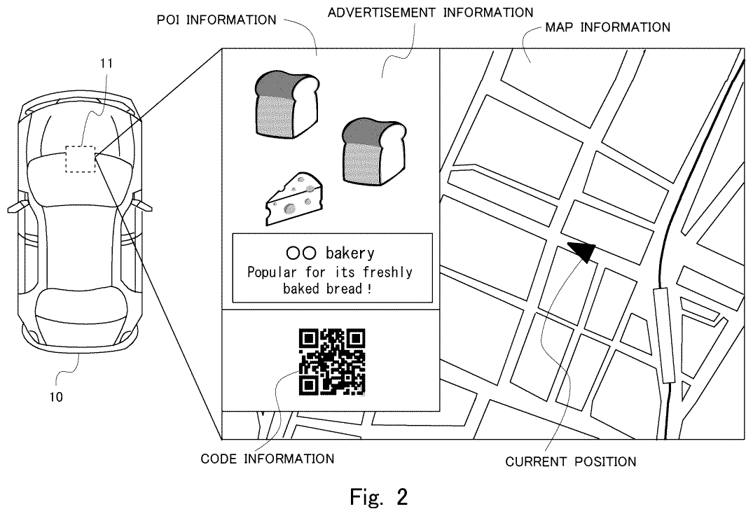

The in-vehicle device 100 displays POI information received from the management server 200 on the in-vehicle display. FIG. 2 is a diagram indicating an example of POI information displayed on the in-vehicle display of the vehicle 10. As indicated in FIG. 2, the in-vehicle display (hereinafter sometimes referred to simply as a display) 11 is installed in the cabin of the vehicle 10 in front of the driver's seat and the passenger seat and at a position between both seats. The display 11 displays map information including the current position of the vehicle 10. Further, POI information received from the management server 200 is superimposed on the map information and displayed on the display 11.

At this time, the POI information may include advertisement information about a product or service related to a specific facility or a specific place. Further, the POI information may include code information (for example, a barcode or a QR code (registered trademark)) in a format readable by the terminal. The code information in this case may include, for example, information (URLs, etc.) about access destinations for more detailed information about a specific facility or a specific place. Further, the code information may be a payment code used for payment when a passenger on the vehicle 10 orders a product or service related to a specific facility or a specific place.

Further, the management server 200 may select POI information to be transmitted to the in-vehicle device 100 based on the distance from the current position of the vehicle 10 to the destination or the like. For example, when the route guidance to the newly set destination of the vehicle 10 is started on the display 11 of the vehicle 10, the management server 200 receives route information including the new destination of the vehicle 10 from the in-vehicle device 100. In this case, the management server 200 may select recommendation information related to the new destination as POI information immediately after receiving route information including a new destination of the vehicle 10 from the in-vehicle device 100. Further, when the distance from the current position of the vehicle 10 to the destination is relatively far, the management server 200 may select information about facilities or places around the current position of the vehicle 10 as POI information. Then, when the current position of the vehicle 10 approaches the destination, the management server 200 may select information about the facility or place around the destination as POI information. According thereto, information that may be of higher interest to the passenger of the vehicle 10 can be provided to the passenger in a timely manner.

However, when the in-vehicle device 100 receives POI information from the management server 200 during the operation of the vehicle 10, the in-vehicle device 100 determines whether or not to display the POI information on the in-vehicle display. Then, when there is a fellow passenger other than the driver in the vehicle 10 and a predetermined condition determined according to the load of the driver's driving operation is not met, the in-vehicle device 100 displays POI information on the in-vehicle display. That is, during the operation of the vehicle 10, even if POI information is received from the management server 200, if there are no fellow passengers in the vehicle 10 or if predetermined conditions are met, the in-vehicle device 100 does not display POI information on the in-vehicle display. The details of the process of displaying POI information on the in-vehicle display in the in-vehicle device 100 are described below.

### Hardware Configuration

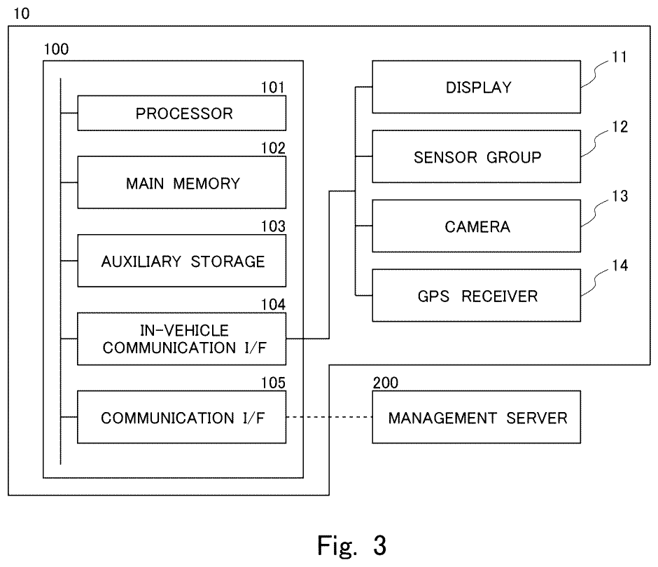

FIG. 3 is a block diagram for explaining the hardware configuration of the in-vehicle device 100 and various devices mounted on the vehicle 10. The in-vehicle device 100 includes a processor 101, a main storage 102, an auxiliary storage 103, an in-vehicle communication interface (in-vehicle communication I/F) 104, and a communication interface (communication I/F) 105.

Here, processor 101 is, for example, a CPU (Central Processing Unit) or DSP (Digital Signal Processor). The main memory 102 is, for example, RAM (Random Access Memory). The auxiliary storage 103 is, for example, ROM (Read Only Memory), HDD (Hard Disk Drive), or flash memory. Auxiliary storage 103 may also include removable media (portable recording media). Examples of the removable medium include a USB memory, an SD card, and disc recording media, such as a CD-ROM, a DVD, and a Blu-ray disc.

The in-vehicle communication I/F 104 is an interface for communicating with other devices provided in the vehicle 10 by the in-vehicle device 100 using a predetermined in-vehicle communication standard. Examples of the predetermined in-vehicle communication standard include CAN (Controller Area Network) and LIN (Local Interconnect Network).

The communication I/F 105 is an interface for connecting the in-vehicle device 100 to the network N1. The communication I/F 105, for example, uses a prescribed wireless communication standard such as 3G (3rd Generation) or LTE (Long Term Evolution) or other prescribed wireless communication standards to connect the in-vehicle device 100 to the network N1. The communication I/F 105 includes, for example, a LAN (Local Area Network) interface board or a wireless communication circuit for wireless communication. Then, information is transmitted/received between the communication I/F 105 and the management server 200 via the network N1.

In the in-vehicle device 100 with the above configuration, an operating system (OS), various types of programs, and various types of information tables are stored in the auxiliary storage 103. When the processor 101 loads and executes the program stored in the auxiliary storage 103 into the main storage 102, the process of displaying for displaying POI information on the display 11 as described later is realized. However, some or all of the functions in the in-vehicle device 100 may be realized by hardware circuits such as ASICs or FPGAs. Note that the in-vehicle device 100 does not necessarily need to be realized by a single physical configuration, but may be configured by a plurality of computers that cooperate with each other. In the present embodiment, the in-vehicle device 100 corresponds to an “information processing apparatus” according to the first aspect of the present disclosure.

The vehicle 10 is provided with various devices such as a display 11, a sensor group 12, a camera 13, and a GPS receiver 14. The in-vehicle device 100 communicates with these devices by the in-vehicle communication I/F 104.

As described above, the display 11 is an in-vehicle display provided in the vehicle interior. The sensor group 12 includes various sensors provided in the vehicle 10. Sensors included in the sensor group 12 are, for example, vehicle speed sensors, acceleration sensors, angular acceleration sensors, accelerator opening sensors, steering angle sensors, gear position sensors, seat belt sensors, and weight sensors. The vehicle speed sensor detects the speed of the vehicle 10. The acceleration sensor detects the acceleration of the vehicle 10. The angular acceleration sensor detects the angular acceleration of the vehicle 10. The accelerator opening sensor detects the accelerator opening of the vehicle 10. The steering angle sensor detects the steering angle of the vehicle 10. The gear position sensor detects the position of the gear in the transmission. A seat belt sensor and a weight sensor are provided in each seat of the vehicle 10. The seat belt sensor detects whether or not a seat belt is attached in each seat of the vehicle 10. The weight sensor detects the magnitude of the load on each seat of the vehicle 10. The camera 13 captures an image of the vehicle interior of the vehicle 10. The GPS receiver 14 is a device that detects the current position of the vehicle 10 in a GPS (Global Position System).

### Functional Configuration

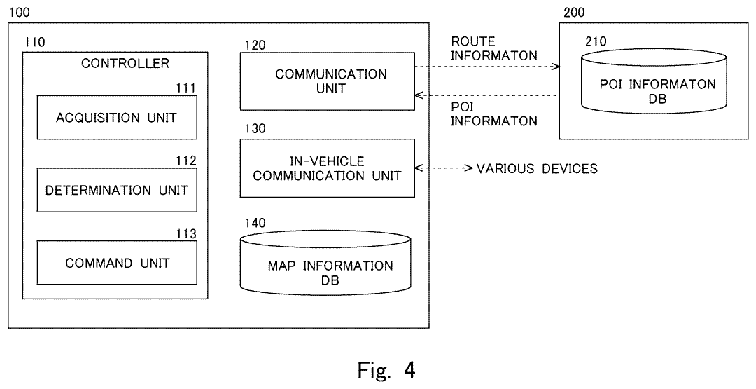

Next, the functional configuration of the in-vehicle device 100 will be described with reference to FIG. 4 FIG. 4 is a block diagram schematically indicating an example of the functional configuration of the in-vehicle device 100. The in-vehicle device 100 includes a controller 110, a communication unit 120, an in-vehicle communication unit 130, and a map information database (map information DB) 140. The controller 110 has the function of performing arithmetic operations to control the in-vehicle device 100. The controller 110 can be realized by the processor 101.

The communication unit 120 has the function of connecting the in-vehicle device 100 to the network N1. The communication unit 120 includes a communication I/F 105. The communication unit 120 can communicate with the management server 200 via the network N1. The in-vehicle communication unit 130 has a function of communicating with various devices in the vehicle 10 including the display 11, the sensor group 12, the camera 13, and the GPS receiver 14. The in-vehicle communication unit 130 includes in-vehicle communication I/F 104. The map information DB 140 stores map information displayed on the display 11. The map information DB 140 is constructed in the auxiliary storage 103.

In the in-vehicle device 100, the controller 110 generates route information of the vehicle 10. The controller 110 generates route information of the vehicle 10 based on the map information stored in the map information DB 140, the current position of the vehicle 10 detected by the GPS receiver 14, and the destination of the vehicle 10 input by the driver (or fellow passenger). Then, the controller 110 executes a process of transmitting the route information of the vehicle 10 to the management server 200 using the communication unit 120. The transmission of route information from the in-vehicle device 100 to the management server 200 is repeatedly executed at a predetermined interval.

The management server 200 has a POI information database (POI information DB) 210. The POI information DB 210 stores POI information received from servers related to various facilities or places. The management server 200 extracts information to be transmitted to the vehicle 10 from the POI information stored in the POI information DB 210 based on the route information of the vehicle 10 received from the in-vehicle device 100. Then, the extracted POI information is transmitted from the management server 200 to the in-vehicle device 100. In the in-vehicle device 100, the controller 110 executes a process of receiving POI information transmitted from the management server 200 using the communication unit 120.

Further, the controller 110 includes an acquisition unit 111, a determination unit 112, and a command unit 113 as a functional unit for realizing the process of displaying POI information on the display 11. When the controller 110 receives POI information from the management server 200 during operation of the vehicle 10, the control unit 110 executes a process for determining whether or not to display the POI information on the display 11.

Specifically, in the controller 110, the acquisition unit 111 acquires the detection value of each sensor included in the sensor group 12, the in-vehicle image captured by the camera 13, and the current position of the vehicle 10 detected by the GPS receiver 14. Then, the determination unit 112 determines whether or not there is a fellow passenger in the vehicle 10 based on at least one of the seat belt sensor detection value, the weight sensor detection value, and the vehicle interior image acquired by the acquisition unit 111. For example, if the seat belt of a seat other than the driver's seat is attached in the vehicle 10, the determination unit 112 may determine that there is a fellow passenger in the vehicle 10. Further, if a load of a predetermined weight or more is applied in a seat other than the driver's seat in the vehicle 10, the determination unit 112 may determine that there is a fellow passenger in the vehicle 10.

Further, when the determination unit 112 determines that there is a fellow passenger in the vehicle 10, the determination unit 112 further determines whether or not a predetermined condition is met based on at least one of the detection values of each sensor and the current position of the vehicle 10 acquired by the acquisition unit 111. Here, the predetermined condition is a condition in which the load of the driver's driving operation is higher when the predetermined condition is met than when the predetermined condition is not met. As the predetermined condition, the following examples (i) to (iv) can be exemplified. However, the following (i) to (iv) are only examples, and other conditions may be set as the predetermined conditions.
(i) The vehicle 10 is traveling in a predetermined section.
(ii) The vehicle 10 is temporary stopped;
(iii) The vehicle 10 is in lane change operation.
(iv) The vehicle 10 is in a parking operation (an operation for parking the vehicle 10).

As the “predetermined section” in (i) above, examples can be made of predetermined traffic restriction section, curve section, intersections with other lane, railroad crossing, tunnel entrance/exit, and the like. Here, the traffic restriction in the “predetermined traffic restriction section” may be either a steady regulation or a temporary regulation. Further, the predetermined sections may be set in advance in the map information stored in the map information DB 140. In this case, whether or not the above (i) is established can be determined based on the current position of the vehicle 10 and the map information. That is, if the current position of the vehicle 10 is at a place set in the predetermined section on the map, it can determined that the above (i) is established.

Further, the current running state of the vehicle 10 can be grasped from the detection value of each sensor included in the sensor group 12. Whether or not (ii), (iii), or (iv) are established can also be determined based on at least one of the current running state of the vehicle 10 and the current position of the vehicle 10.

Then, when it is determined by the determination unit 112 that the predetermined conditions have not been met, the controller 110 displays POI information on the display 11. Specifically, the command unit 113 transmits a command to the display 11 to display POI information received from the management server 200.

On the other hand, when it is determined by the determination unit 112 that there are no fellow passengers in the vehicle 10, or when it is determined by the determination unit 112 that a predetermined condition is met, the controller 110 does not display POI information on the display 11.

(Flow Process of Displaying)

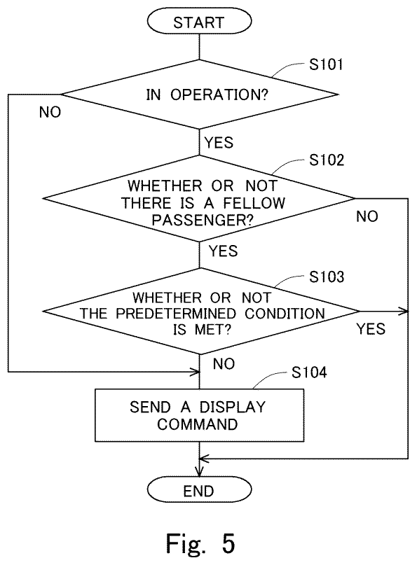

Hereinafter, the flow of the process of displaying according to a first embodiment will be described with reference to FIG. 5. FIG. 5 is a flowchart indicating the flow of the process of displaying according to the first embodiment. When the in-vehicle device 100 receives POI information from the management server 200, this flow is executed by the controller 110.

In this flow, first, in S101, it is determined whether or not the vehicle 10 is in operation. If it is determined to be negative in S101, that is, when the vehicle 10 is parked, the process of S104 is executed next. In S104, a command is sent to the display 11 to display POI information received from the management server 200. Thereby, POI information is displayed on the display 11. Then, the execution of this flow is terminated.

On the other hand, when it is affirmative in S101, that is, when the vehicle 10 is in operation, the process of S102 is executed next. In S102, it is determined whether or not there is a fellow passenger in the vehicle 10. When it is determined to be negative in S102, that is, when there is no fellow passenger in the vehicle 10, the execution of this flow is terminated. In this case, the command to display POI information is not sent to the display 11. Therefore, POI information is not displayed on the display 11.

On the other hand, if it is affirmed in S102, the process of S103 is executed next. In S103, it is determined whether or not a predetermined condition is met. Specifically, it is determined whether any of (i) through (iv) above is satisfied. If it is affirmed in S103, that is, if any of (i) to (iv) above is satisfied, the execution of this flow is terminated. Again, the command to display POI information is not sent to the display 11. Therefore, POI information is not displayed on the display 11.

On the other hand, when it is determined to be negative in S103, that is, when neither of (i) to (iv) above is satisfied, the process of S104 is executed next. Thereby, POI information is displayed on the display 11. Then, the execution of this flow is terminated.

### Effects and Effects

According to the above process of displaying, during the operation of the vehicle 10, POI information can be provided to a fellow passenger while suppressing as much as possible that the display of POI information on the display 11 affects the driver's driving operation. Thereby, compared with the case where POI information is controlled so that POI information is displayed on the display 11 only when the vehicle 10 is parked, the opportunity to provide information that may be useful to passengers on the vehicle 10 can be increased. Therefore, it is possible to display POI information at a more suitable timing on the display 11.

### Second Embodiment

In the present embodiment, the schematic configuration of the information providing system 1 and the hardware configuration of the in-vehicle device 100 are the same as in the first embodiment. However, in the present embodiment, the process of displaying POI information on the display 11 in the in-vehicle device 100 is different from the first embodiment. In the present embodiment, even when there are a fellow passenger other than the driver in the vehicle 10 and the predetermined conditions are not met, when the driver's state is in a predetermined state, the in-vehicle device 100 does not display POI information on the display 11.

In the in-vehicle device 100, the controller 110 detects the driver's state based on the in-vehicle image captured by the camera 13. The driver's state detected here is specifically the direction of the driver's line of sight and the position of the driver's hands.

(Flow Process of Displaying)

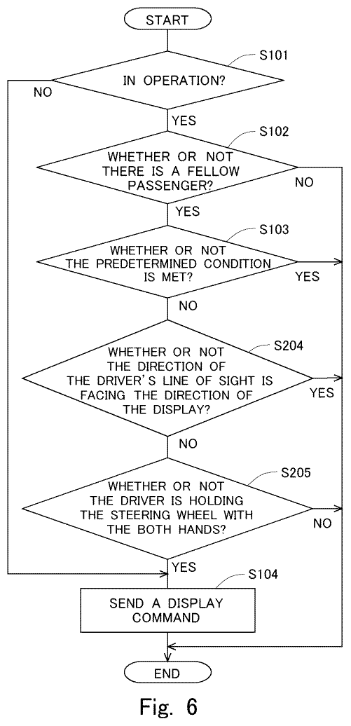

Hereinafter, the flow of the process of displaying according to the second embodiment will be described with reference to FIG. 6. FIG. 6 is a flowchart indicating the flow process of displaying according to the second embodiment. When the in-vehicle device 100 receives POI information from the management server 200, this flow is executed by the controller 110. The processes executed in S101 to S104 in this flow are the same as the processes executed in the steps of the same reference number in the flow indicated in FIG. 5. Therefore, the description of these steps is omitted.

In this flow, if it is determined to be negative in S103, the process of S204 is executed next. In S204, it is determined whether or not the direction of the driver's line of sight detected based on the in-vehicle image is facing the direction of the display 11. When it is affirmed in S204, that is, when the direction of the driver's line of sight is facing the direction of the display 11, the execution of this flow is terminated. In this case, the command to display POI information is not sent to the display 11. Therefore, POI information is not displayed on the display 11.

On the other hand, when it is determined to be negative in S204, that is, when the driver's line of sight is not facing the direction of the display 11, the processing of S205 is executed next. In S205, it is determined whether or not the driver is holding the steering wheel of the vehicle 10 with both hands. If it is determined to be negative in S205, that is, when the driver is not holding the steering wheel with both hands, the execution of this flow is terminated. Again, the command to display POI information is not sent to the display 11. Therefore, POI information is not displayed on the display 11.

On the other hand, if it is affirmative in S205, that is, when the driver is holding the steering wheel with both hands, the process of S104 is executed next. Thereby, POI information is displayed on the display 11. Then, the execution of this flow is terminated.

### Effects and Effects

In the vehicle 10, when POI information is displayed on the display 11 when the direction of the driver's line of sight is facing the direction of the display 11, the driver's driving operation may be affected. Further, when the driver is not holding the steering wheel with both hands, there is a possibility that the driver's concentration on the driving operation of the vehicle 10 is reduced. Therefore, even if POI information is displayed on the display 11 when the driver is not holding the steering wheel with both hands, the driver's driving operation may be affected.

Therefore, according to the process of displaying according to the present embodiment, when the direction of the driver's line of sight is facing the direction of the display 11, or when the driver is not holding the steering wheel with both hands, the display 11 does not display POI information. According to this, during the operation of the vehicle 10, it is possible to suppress with a higher probability that the display of POI information on the display 11 affects the driver's driving operation.

### OTHER EMBODIMENTS

The embodiments described above are merely examples, and the present disclosure may be changed and implemented as appropriate within the scope of the disclosure. Furthermore, processes and means described in the present disclosure may be freely combined to the extent that no technical conflict exists.

Furthermore, a process that is described to be performed by one apparatus may be shared and performed by a plurality of apparatuses. Processes described to be performed by different apparatuses may be performed by one apparatus. Which function is to be implemented by which hardware configuration (server configuration) in a computer system may be flexibly changed.

The present disclosure may also be implemented by supplying computer programs for implementing the functions described in the embodiments described above to a computer, and by one or more processors of the computer reading out and executing the programs. Such computer programs may be provided to the computer by a non-transitory computer-readable storage medium that can be connected to a system bus of the computer, or may be provided to the computer through a network. The non-transitory computer-readable storage medium may be any type of disk including magnetic disks (floppy (registered trademark) disks, hard disk drives (HDDs), etc.) and optical disks (CD-ROMs, DVD discs, Blu-ray discs, etc.), and any type of medium suitable for storing electronic instructions, such as read-only memories (ROMs), random access memories (RAMs), EPROMs, EEPROMs, magnetic cards, flash memories, or optical cards.

What is claimed is:

1. An information processing apparatus comprising a controller, wherein
during the operation of a vehicle, when there is a fellow passenger in the vehicle and a predetermined condition determined according to the load of the driving operation of a driver of the vehicle is not met, the controller displays POI (Point of Interest) information on an in-vehicle display of the vehicle.

2. The information processing apparatus according to claim 1, wherein
during the operation of the vehicle, when there is no fellow passenger in the vehicle or when the predetermined condition is met, the controller does not display the POI information on the in-vehicle display.

3. The information processing apparatus according to claim 1, wherein
during the operation of the vehicle, even when there is a fellow passenger in the vehicle and the predetermined condition is not met, if the driver's line of sight is directed in the direction of the in-vehicle display, the controller does not display the POI information on the in-vehicle display.

4. The information processing apparatus according to claim 1, wherein
during the operation of the vehicle, even when there is a fellow passenger in the vehicle and the predetermined condition is not met, if the driver does not hold the steering wheel with both hands, the controller does not display the POI information on the in-vehicle display.

5. The information processing apparatus according to claim 1, wherein
the predetermined condition includes at least one of the following: the vehicle is traveling in a predetermined section, the vehicle is at a temporary stop, the vehicle is in a lane change operation, and the vehicle is in a parking operation.

6. The information processing apparatus according to claim 5, wherein
the predetermined section includes at least one of a predetermined traffic restriction section, a curve section, an intersection, a merging point with another lane, a railroad crossing, and a tunnel entrance/exit.

7. The information processing apparatus according to claim 1, wherein
the controller determines whether or not there is a fellow passenger in the vehicle based on at least one of an image of the vehicle cabin captured by a camera provided in the vehicle and a detection value of a sensor provided in the vehicle.

8. The information processing apparatus according to claim 1, wherein
the controller determines whether or not the predetermined condition is met based on at least one of the current position of the vehicle while traveling and the detection value of a sensor provided in the vehicle.

9. The information processing apparatus according to claim 1, wherein
the POI information displayed on the in-vehicle display includes advertisement information.

10. The information processing apparatus according to claim 1, wherein
the POI information displayed on the in-vehicle display includes code information in a format that can be read by a terminal.

11. A vehicle equipped with
the information processing apparatus according to claim 1; and
an in-vehicle display.

12. A non-transitory storage medium that stores a program that controls a computer mounted on a vehicle, wherein
during the operation of a vehicle, when there is a fellow passenger in the vehicle and a predetermined condition determined according to the load of the driving operation of a driver of the vehicle is not met, the program causes the computer to display POI (Point of Interest) information on an in-vehicle display of the vehicle.

13. A non-transitory storage medium according to claim 12, wherein
during the operation of the vehicle, when there is no fellow passenger in the vehicle or when the predetermined condition is met, the program causes the computer not to display the POI information on the in-vehicle display.

14. The non-transitory storage medium according to claim 12, wherein
during the operation of the vehicle, even when there is a fellow passenger in the vehicle and the predetermined condition is not met, if the driver's line of sight is directed in the direction of the in-vehicle display, the program causes the computer not to display the POI information on the in-vehicle display.

15. The non-transitory storage medium according to claim 12, wherein
during the operation of the vehicle, even when there is a fellow passenger in the vehicle and the predetermined condition is not met, if the driver does not hold the steering wheel with both hands, the program causes the computer not to display the POI information on the in-vehicle display.

16. The non-transitory storage medium according to claim 12, wherein
the predetermined condition includes at least one of the following: the vehicle is traveling in a predetermined section, the vehicle is at a temporary stop, the vehicle is in a lane change operation, and the vehicle is in a parking operation.

17. The non-transitory storage medium according to claim 16, wherein
the predetermined section includes at least one of a predetermined traffic restriction section, a curve section, an intersection, a merging point with another lane, a railroad crossing, and a tunnel entrance/exit.

18. A non-transitory storage medium according to claim 12, wherein
the program causes the computer to determine whether or not there is a fellow passenger in the vehicle based on at least one of an image of the vehicle cabin captured by a camera provided in the vehicle and a detection value of a sensor provided in the vehicle.

19. A non-transitory storage medium according to claim 12, wherein
the program causes the computer to determine whether or not the predetermined condition is met based on at least one of the current position of the vehicle while traveling and the detection value of a sensor provided in the vehicle.
